(19) United States
(12) Patent Application Publication
(10) Pub. No.: US 2009/0046065 A1
(43) Pub. Date: Feb. 19, 2009

(54) SENSOR-KEYPAD COMBINATION FOR MOBILE COMPUTING DEVICES AND APPLICATIONS THEREOF

(76) Inventors: Eric Liu, Sant Clara, CA (US); Stephen Lee, Seattle, WA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/840,916

(22) Filed: Aug. 17, 2007

(51) Int. Cl. G06F 3/02

(52) U.S. Cl. 345/168

(57) ABSTRACT

A key structure layer is provided on the panel segment. The key structure layer may be combined with sensors that detect a position of a finger or other object at any region on the key structure layer. When contact with the key structure layer pushes the panel segment inward, the processing resources of the mobile computing device recognize the contact by the finger or object as a key-press event. Position information from the sensors assign a key value to the key-press event.

### TECHNICAL FIELD

The disclosed embodiments relate generally to the field of mobile computing devices. In particular, the disclosed embodiments pertain to a keypad or other form of input mechanism for a mobile computing device.

### BACKGROUND

Over the last several years, the growth of cell phones and messaging devices has increased the need for keypads and button/key sets that are small and tightly spaced. In particular, small form-factor keyboards, including QWERTY layouts, have become smaller and more tightly spaced. With decreasing overall size, there has been greater focus on efforts to provide functionality and input mechanisms more effectively on the housings.

In addition to a keyboard, mobile computing devices and other electronic devices typically incorporate numerous buttons to perform specific functions. These buttons may be dedicated to launching applications, short cuts, or special tasks such as answering or dropping phone calls. The configuration, orientation and positioning of such buttons is often a matter of concern, particularly when devices are smaller.

### BRIEF DESCRIPTION OF THE DRAWINGS

FIG. 1A is a frontal view of a mobile computing device structured to include a moveable platform segment, in accordance with an embodiment of the invention.

FIG. 1B and FIG. 1C are illustrative side cross-sectional views of the device 10 along lines A-A of FIG. 1A.

FIG. 1D is a simplified side cross-sectional view of a keypad assembly of a mobile computing device that incorporates a moveable platform segment, according to an embodiment of the invention.

FIG. 2A is a frontal view of a mobile computing device on which a keyboard such as shown and described by an embodiment of FIG. 1D is provided.

FIG. 2B illustrates an implementation of a key value assignment scheme for a particular keypad layout, according to an embodiment of the invention.

FIG. 3A is a simplified side view of a keypad assembly that includes positional backlighting variation to alter graphics and content appearing on a key of a keypad, according to an embodiment of the invention.

FIG. 3B and FIG. 3C illustrate an implementation of an embodiment of FIG. 3A, in which light-emitting layer 340 may be operated to selectively illuminate under portions of individual key structures, so as to illuminate and/or darken one portion of a key structure from another.

FIG. 4A is a side view of a keypad assembly that includes a display screen to enable computer-generated graphics to define keys and/or contents of keys on a keypad, according to an embodiment of the invention.

FIG. 4B and FIG. 4C illustrate an embodiment in which keypad 405 of an embodiment of FIG. 4A can change graphics.

FIG. 4D illustrates an embodiment in which a number pad 470 is enlarged and appears in a greater area than what was shown with an embodiment of FIG. 4C.

FIG. 5 is a simplified hardware diagram of a computing device configured to implement one or more embodiments of the invention.

### DETAILED DESCRIPTION

Embodiments described herein provide for a mobile computing that has a platform segment that is provided with or as part of the housing. The platform segment occupies a portion of a facade on which a keypad or other input interface is provided. In one embodiment, the mobile computing device includes a coupling mechanism that couples the platform segment to at least a portion of the housing. The platform segment may be moved inwards and outwards with respect to an interior of the housing. As described in greater detail, the inward movement of the housing causes the processing resources of the device to make a specific interpretation of a user-initiated contact with the interface.

In one embodiment, a key structure layer is provided on the panel segment. The key structure layer may be combined with sensors that detect a position of a finger or other object at any region on the key structure layer. When contact with the key structure layer pushes the panel segment inward, the processing resources of the mobile computing device recognize the contact by the finger or object as a key-press event. Position information from the sensors assign a key value to the key-press event.

Either of an illumination layer or a display component may be combined with the panel segment to illuminate light through the key structure layer. The illumination layer may be used to hide or diminish the imprints of key values on the key structure layer, and/or to enhance the display of some key value imprints over another adjacent key value imprint. Multiple key value imprints may be provided on one key structure.

In another embodiment, the display component may illuminate graphics or other content through the key structure layer. The illumination from the display component may provide content corresponding to key value assignments, as well as other content that may be carried as part of a key of a keypad. The operation of the keypad may be switched between modes (such as between alphabet and numeric modes), and the display component may be used to display key values for a particular mode of operation. In one implementation, the display component displays only the key values for a particular mode of operation, and does not display key values for other modes of operation.

Still further, one or more embodiments provide that a display component may generate graphics illuminated through the key structure layer that define or delineate keys of the keypad, including the shape or dimension of the individual keys and/or layout of individual keys in the keypad.

According to one embodiment, a mobile computing device includes a housing, a key structure layer, a position sensor, and a processing resource. The housing may provide a front surface that includes a panel segment. The key structure layer may be provided with or as part of the panel segment of the housing. A processing resource of the device may be configured to associate each of a plurality of regions of the key structure layer with a corresponding key value. The position sensor may be provided in operational proximity to the panel segment and coupled to the processing resource to detect a position of an object that is in contact with, or in proximity to, the key structure layer. An actuation mechanism is positioned with respect to the panel to be actuated when a force is applied to any portion of the key structure layer that exceeds a threshold range. The actuation mechanism may be coupled to the processing resource to signal the processing resource when actuated. The processing resource may be configured to identify the key value associated with the position of the object when the actuation mechanism is actuated.

According to another embodiment, keypad assembly is provided for a mobile computing device. The keypad assembly includes a platform segment provided on or as part of a housing of the mobile computing device. The platform segment may include a keypad surface that occupies a portion of a front face of the device. The keypad assembly may also include coupling mechanism that couples the platform segment to at least a portion of the housing, so as to enable the platform segment to be moved inwards and outwards with respect to an interior of the housing.

According to another embodiment, segment for a housing of a mobile computing device includes a platform segment, a key structure layer, and a coupling mechanism. The platform segment may be provided on or as part of the housing of the mobile computing device. A key structure layer is provided on the platform segment. The key structure layer includes a keypad surface that occupies a portion of a front face of the device. A coupling mechanism may couple the platform segment to at least a portion of the housing so as to enable the platform segment to be moved inwards and outwards with respect to an interior of the housing.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Platform Segment

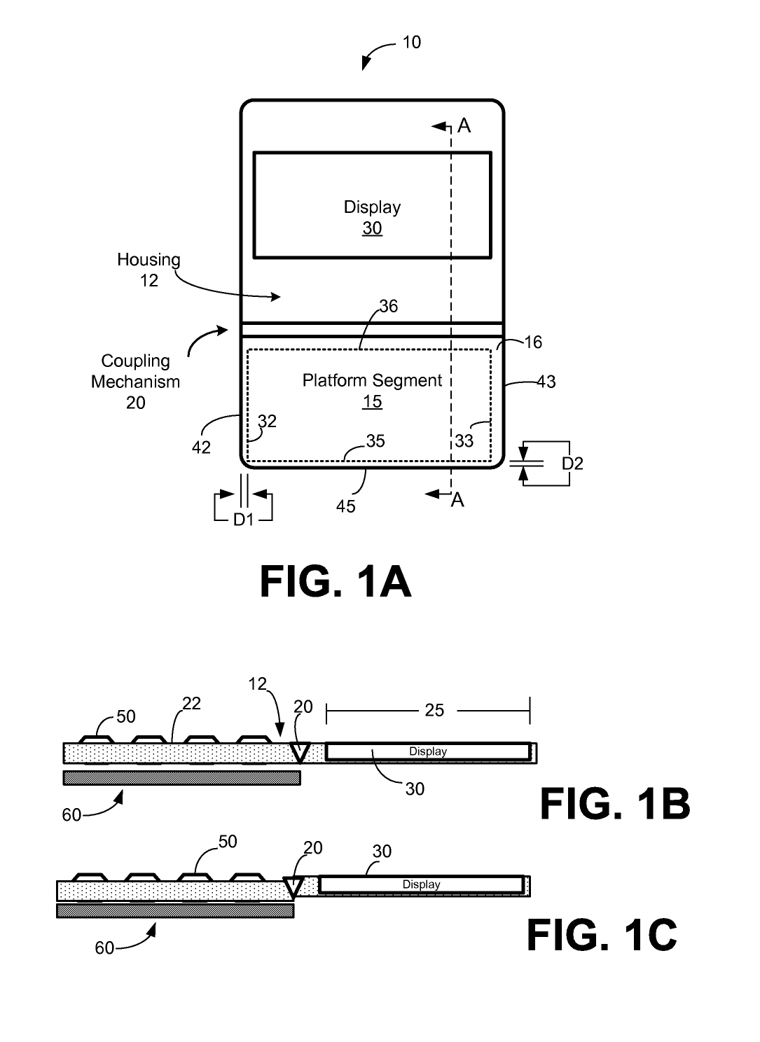

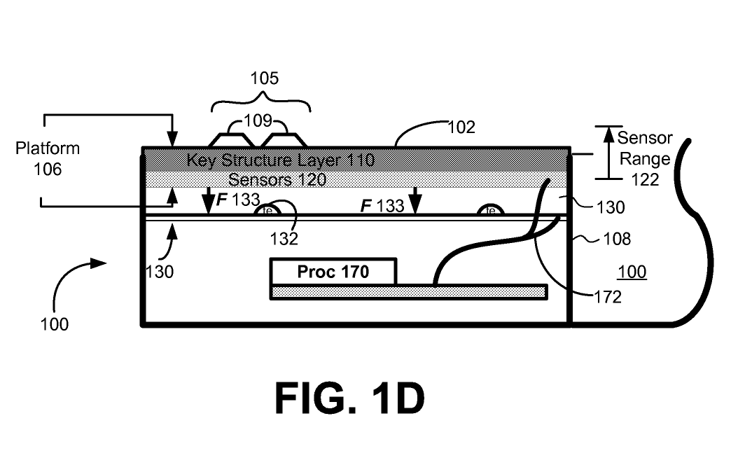

FIG. 1A is a frontal view of a mobile computing device structured to include a moveable platform segment, in accordance with an embodiment of the invention. A mobile computing device 10 of FIG. 1A may correspond to, for example, a cellular data and/or telephony device for enabling messaging activities and/or data entry functionality. Messaging activity may correspond to, for example, composing email messages, instant messages, Short Message Service (SMS) or Multimedia Message Service (MMS) messages. Data entry functionality may correspond to, for example, word processing and editing, web browsing (e.g. entering URL addresses), online blogging (interacting with an online medium and posting messages online), and recording information in records such as electronic contacts, notes and memorandums.

The mobile computing device 10 includes a housing 12 that retains components such as processing resources, memory, and wireless communication components (such as wireless modules, processors, and/or antennas). The device 10 may also include a display 30. In one implementation, display 30 is interactive, in that it is contact-sensitive or sensitive to light variations.

According to an embodiment, mobile computing device 10 includes a platform segment 15 that is provided with or as part of housing 12. The platform segment 15 is coupled to a portion of housing 12 via a coupling mechanism 20. The coupling mechanism 20 enables the platform segment 15 to move inward, either by pivot or linearly, depending on the coupling mechanism's structure and orientation.

In one embodiment, the platform segment spans a majority portion (greater than 50%) of a widthwise dimension of the device 10. In an implementation shown, the platform segment 15 spans the entire width W of the device 10, at a bottom end segment 16 of the device 10. Thus, lateral edges 32, 33 of the platform segment 15 may coincide with lateral edges 42, 43 of the housing 12 or its front face. Alternatively, a distance D1 may separate each of the lateral sides 32, 33 from the corresponding edge 42, 43.

According to one embodiment, the coupling mechanism 20 may correspond to an arrangement of one or more hinges or joints that collectively enable the platform segment 15 to pivot inward. The coupling mechanism 20 and/or platform 15 may be biased so as to move outward in the absence of an applied force, such as from a user's finger. As a result of a pivot motion, a bottom end 35 of the platform segment 15 may traverse further inward than a top end 36. In an implementation shown, the bottom end 35 coincides with a bottom edge 45 of the housing 12 or its front face. However, other implementations may separate the bottom end 15 from the bottom edge 45 of the housing 12 by distance D2. In one implementation, the top end 36 coincides with a pivot point of the coupling mechanism 20.

As shown in FIG. 1B and FIG. 1C, inward traversal of the platform segment 15 may trigger or actuate signals which result in some function or operation being performed by the processing resource and/or other internal resource of the device. As described with other embodiments provided below, the additional function or operation may correspond to the recognition that contact with key structures 50 (see FIG. 1B or FIG. 1C) or areas is to be interpreted as keyboard/keypad entry. However, other embodiments may provide for the inward entry to be recognized as an application related operation, such as a “short-cut” or quick action (e.g. application launch). Still further, the actuation or trigger signal resulting from the inward movement of the platform 15 may be recognized as a device or hardware control, such as specifying a power state of the device, display, backlight or wireless radio. The power state may include switching on, off, or low (but not off) states.

Numerous variations may be used for coupling mechanism 20, instead of hinges or joints. In one implementation, the coupling mechanism 20 may be provided proximate or at the bottom end 35 of the platform segment 15, rather than at or near the top end 36. Still further, the platform segment 15 may be pushed in from multiple sides in a non-pivoting or otherwise linear fashion. For example, the platform segment 15 may be affixed to a deformable or spring layer that can be pushed inward. When pushed inward, the platform segment 15 may bias outward, so as to move outward in the absence of an applied force (such as from a user's finger).

FIG. 1B and FIG. 1C are illustrative side cross-sectional views of the device 10 along lines A-A of FIG. 1A. Platform segment 15 resides over an actuation mechanism 60. The housing 12 includes a front face 22 that includes an area 25 for display 30. Additionally, in one embodiment, a plurality of key structures 50 extend from or are provided in connection with the platform segment 15. In one embodiment, coupling mechanism 20 may separate portions of housing 12 providing display 30 and platform segment 15. The platform segment 15 is moveable as a whole inward into the housing to actuate the mechanism 60. In one embodiment, the actuation mechanism 60 is in the form of a platform that spans a majority of the region or area underling the platform 15. Any threshold inward movement of the platform 15 may be sufficient to generate an actuation signal from mechanism 60. In one embodiment, the same signal is generated from the threshold inward movement of the platform segment 15.

In FIG. 1B, platform segment 15 is shown in a raised position. In one embodiment, actuation mechanism 60 is contact-sensitive, so that a separation exists between the platform segment and the actuation mechanism. However, in other embodiment, the actuation mechanism 60 may be in continuous contact with the platform segment 15. For example, the actuation mechanism 60 may be resistive to detect the threshold inward movement.

In one embodiment, key structures 50 are not actuatable independent of the inward movement of the platform segment 15. As such, key structures 50 may only provide keypad functionality when platform segment 15 is moved inwards to trigger the actuation signal from mechanism 60. As an alternative, the inward movement of the platform segment may provide ancillary function to independent functionality provided by the key structures 50. Still further, the inward movement of the platform segment 15 may provide alternative functionality to the operability of the key structures 50.

Embodiments described herein provide for a keypad, or keypad type input device, that enables the user to specify position information on an area of the keypad independent of specifying any one key value.

Platform Segment with Key Structure Layer

FIG. 1D is a simplified side cross-sectional view of a keypad assembly of a mobile computing device that incorporates a moveable platform segment, according to an embodiment of the invention. A device 100 includes a platform segment 106 such as shown and described with any of the embodiments of FIG. 1A-FIG. 1C. The platform segment 106 may be provided with or as part of the device's housing 108. A keypad 105 may be provided as part of the platform segment 106. The keypad 105 includes key structure layer 110, one or more sensors 120 (or sensor layer) and an actuation platform 130. A contact surface 102 may be provided with the key structures 105. The sensors 120 and the actuation platform 130 may each be coupled to processing resources 170 housed within the device. In one implementation, processing resources 170 correspond to a processor that is provided on an internal printed circuit board and coupled to the actuation platform 130 and sensors 120 through use of one or more flex cables 172.

The keypad 105 may be operational (with use of processing resources 170) to enable a user to enter alphabet, numbers, alternative characters (e.g. “@”) and/or actuate keys or key structure for performing application or device functions (such as application launch or device control). For example, keypad 105 may be in the form of a QWERTY keyboard with a superimposed or combined numerical pad layout for an alternative mode of operation.

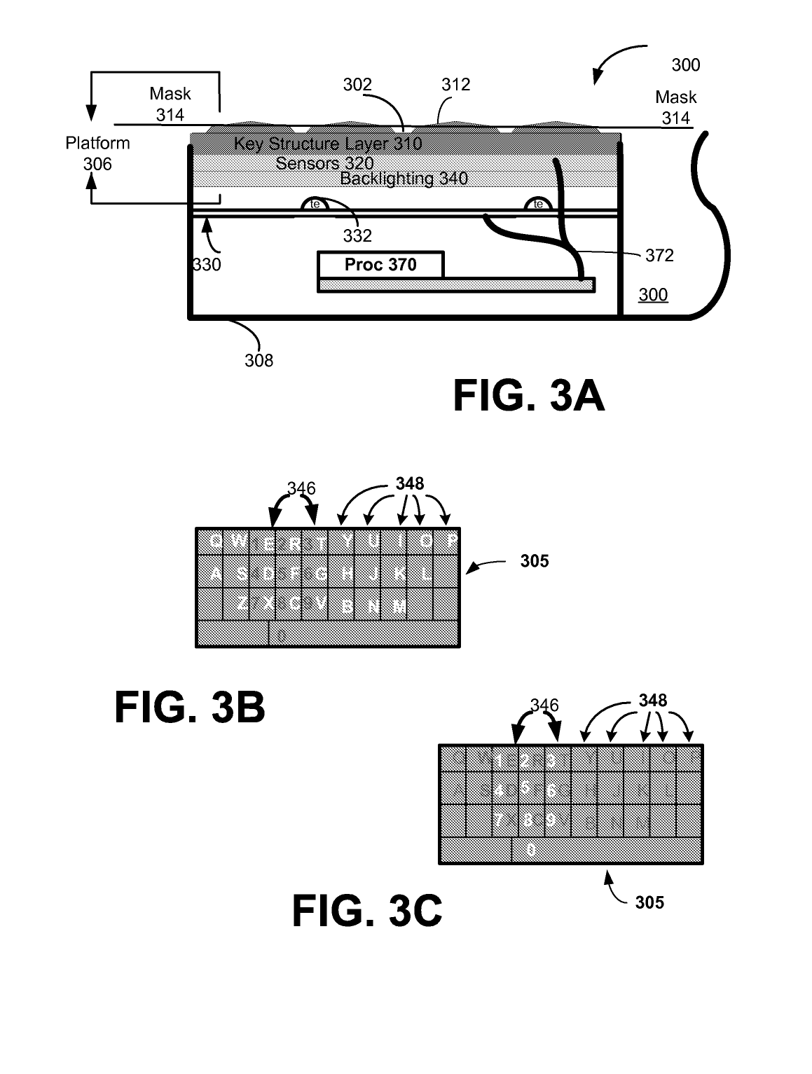

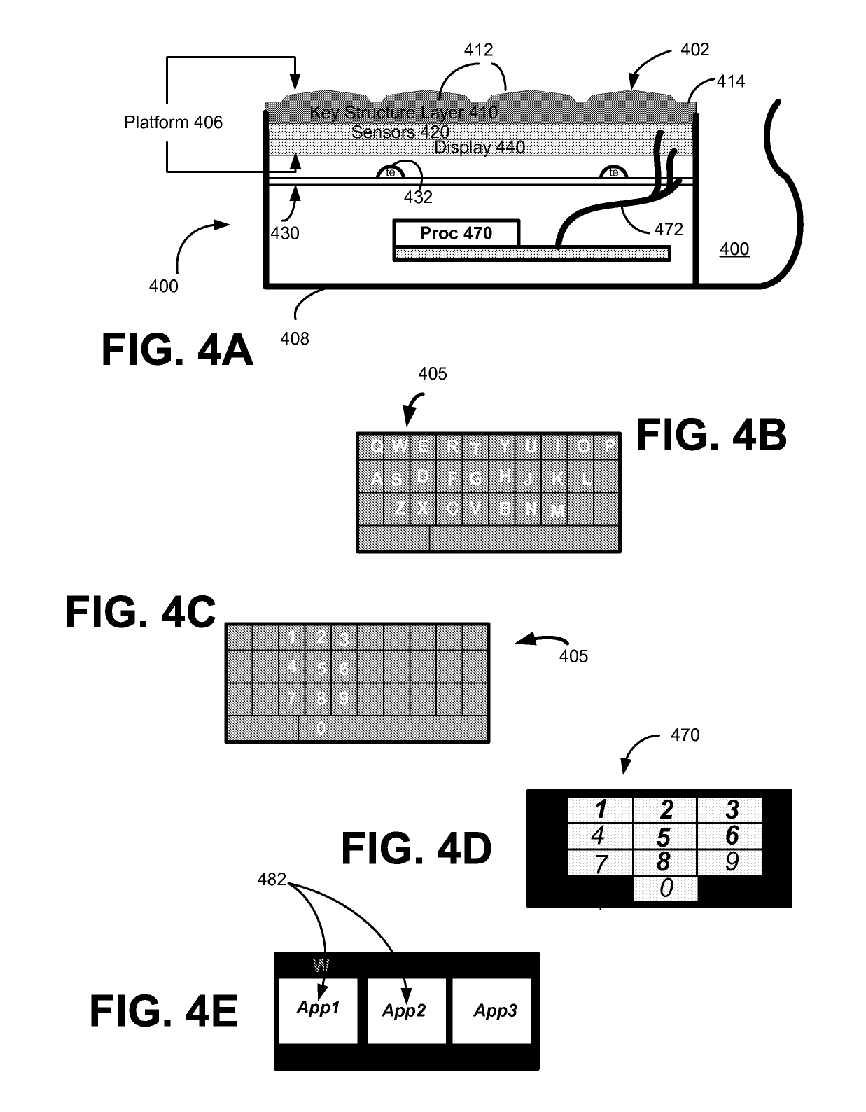

The contact surface 102 is structured or otherwise configured to receive contact by a user's finger or object. In an embodiment, the contact surface 102 may use mechanical features to define input areas that each correspond to a particular key value. Such mechanical features may include separately formed or raised key structures, indents, grooves, protrusions, recesses, and/or visual markers. For example, FIG. 1D illustrates an implementation in which individual keys of the keypad 105 are separated key structure formations 109. Alternative keys of keypad 105 may be provided in the form of a sheet panel with visual markers that define individual keys. Still further, with addition of a lighting area or display assembly, such as described with embodiments of FIG. 3A or FIG. 4A, the contact surface 102 may use light or computer-generated features to define input areas, including the layout displayed to the user.

The sensors 120 are operationally positioned to encompass a thickness of the key structure layer 110, so as to detect the presence of an object or finger on (or optionally in proximity to) contact surface 102. In one implementation, sensors 120 are in the form of a clear touch panel, occupying a thickness or layer underneath the key structure layer. The sensors 120 may couple to the processing resources 170 of the device to provide position information that identifies the location of the finger or object. According to one or more embodiments, the sensors 120 corresponds to a capacitive sensor pad that detects contact or proximity of a finger or other object to the contact surface 102. However, other types of sensors may be used, including resistive and optical sensors. The sensors 120 may occupy or surround a thickness that underlies the contact surface 102 and its corresponding key structure layer 110. Alternatively, the sensors 120 may be combined with the key structure layer 110. In one embodiment, sensors 120 may be in the form of a touchpad that underlies the contact area 102. Alternatively, the sensors 120 may correspond to discretely placed sensors which individually, or in combination with other sensors, provide the processing resources of the device 105 with position information as to the location of a finger or object. As another alternative, the sensors 120 may circumvent a designated area for the keypad 105 as provided for the user, so as to detect the object or finger's position when placed within the designated area. Still further, sensors 120 may be integrated with segments or regions of contact surface 102.

As shown by an embodiment of FIG. 1D, the sensors 120 may include a characteristic sensor range 122 that extends to a plane of or a above the contact surface 102. As such, one or more embodiments provide that the sensors can communicate to the processing resources the presence of an object or a finger positioned just over or on the contact surface 102. In one embodiment, the sensors 120 are capacitive in nature. For example, sensors 120 may be formed from a capacitive indium tin oxide (ITO) sensor. Alternatively, the sensors 120 may be resistive, requiring contact from the finger or object. Still further, one or more embodiments provide for use of optical sensors, which may detect and interpret variations of light cast onto the designated area as a result of the presence of the object or finger.

The actuation platform 130 may comprise a base for the keypad 105, and include one or more switches 132 (or other actuation components) that are triggered by force or contact. When triggered, each switch 132 may send a corresponding signal to the processing resources of the device. Such a trigger signal results in the processing resources recognizing that a user-contact with contact surface 102 is to be interpreted as a key-press event. In one embodiment, the actuation platform 130 may be dimensioned, positioned or otherwise structured to ensure not all user-contact with contact surface 102 is recognized as a key-press event. In one embodiment, the key structure layer 110 and/or the sensors 120 comprise or form part of platform 106 that is inwardly moveable with the application of force from a finger or pointer. The one or more switches 132 of the actuation platform 130 are triggerable with force 133 that exceeds a designated threshold. Such force 133 may be required to (i) move the platform 106 inward, and/or (ii) trigger with contact an underlying switch 132 of the actuation platform 130.

In one implementation, four or more contact domes are provided as the switch element on the actuation platform 130. Domes offer a benefit of cost-savings, but at the same time, different contact forces would be needed on the key structure layer to trigger key-press events. Fewer snap-domes may also be used, particularly if the platform segment is configured to move inward substantially linearly.

As provided with embodiments such as described with FIG. 1A-1C, platform 106 may be hinged or pivotally connected to the housing of the device at one end. In one embodiment, platform 106 extends under the key structure layer 110 and forms a part of the housing or panel thereof. The platform 106 may be inwardly moveable and positioned sufficiently close to the actuation platform 130 so that a small degree of movement is all that is necessary to cause the key-press event.

In one implementation, the contact switch 132 may correspond to a snap-dome electrical contact. The snap-dome electrical contact includes an outer conductive shell that can be snapped inward when sufficient force is applied (such as force 133 in exceed of threshold range) to contact an inner electrical element, thereby causing generation of an electrical signal. However, numerous other types of switches can be used with embodiments described herein.

In operation, keypad 105 may be used to register two kinds of input. A user may move an object or finger across the contact surface 102, in which a non-key-press input may or may not be recorded. In such an implementation, the input may correspond to, for example, directional or navigation input corresponding that reflects motion and/or position of the object on or over the contact surface 102. Characteristics such as velocity, acceleration or movement in three-dimensions may also be recorded, depending on the capabilities of the sensors 120. Alternatively, the user may move the object inward into contact with surface 102, resulting in one of the switches 132 being triggered. When the switch 132 is triggered, the device treats the user's contact with the contact surface 102 as a key-press event, meaning the contact is to result in identification of a key input or entry. A key value may be determined from position information provided by one or more of the sensors 120. The position information enables the processing resources to determine the object's position at the instance switch 132 is triggered. In this way, the sensor keypad combination works by (i) registering key values only when sufficient force is applied to trigger the contact switch 132, and (ii) determining the individual key values by determining the position of the object about the instance (e.g. just before or after) the contact switch 132 being triggered.

Actuation platform 130 may include multiple switches 132. In one implementation, additional switches serve to provide redundancy in detecting the presence of a force 133 that is sufficient to mark a key value input. Thus, in such an embodiment, the particular switch 132 that is actuated has no bearing on the key value. Furthermore, the fact that multiple switches are simultaneously actuated also has no bearing.

In an embodiment, the actuation platform 130 operates substantially independent of the sensors 120. As such, a position value of the object may be determined without registering a key value. Among other advantages, an embodiment such as described enables a user to move his hand over the keypad in one direction or another to effect directional input.

According to one implementation, platform 106 may be moveable inward to cause switch 132 to trigger. In one implementation, one to four switches are provided underneath the structure. A sum total of a force needed to collapse or otherwise trigger any one switch and to move the platform 106 inward may correspond to the characteristic force that enables contact by the object or pointer to be registered as a key-press event. Furthermore, one or more embodiments provide that the processing resources do not distinguish as to how many or which switches 132 are actuated (if there are more than one switch 132 present). In such embodiments, the actuation of any one switch 132 results in the same trigger signal. Alternatively, however, different switches 132 may have different functions assigned.

Keypad on Moveable Segment

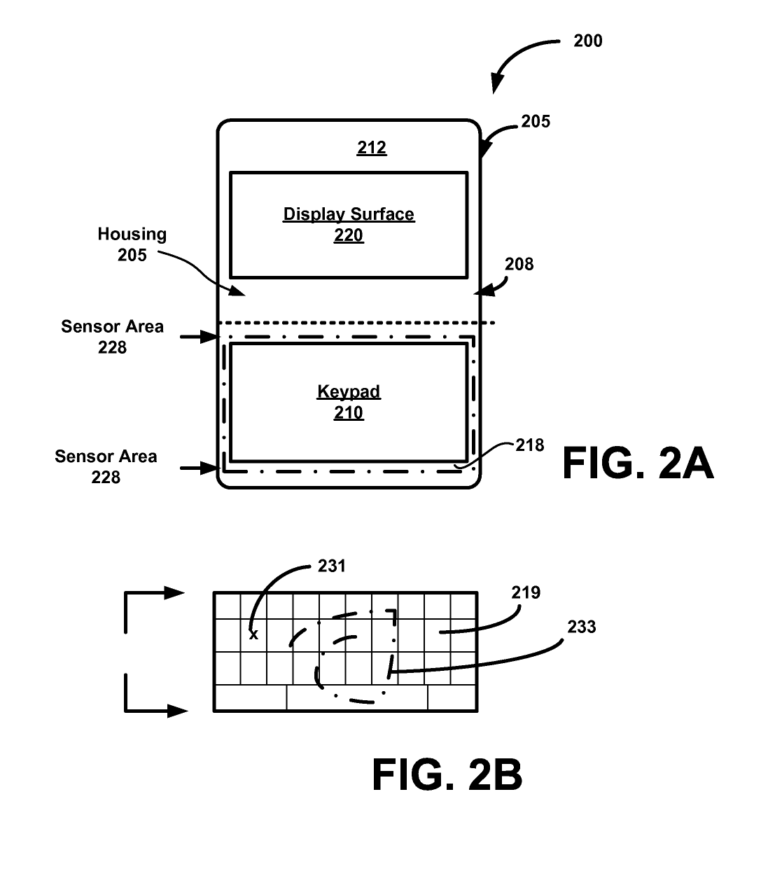

FIG. 2A is a frontal view of a mobile computing device on which a keyboard such as shown and described by an embodiment of FIG. 1D is provided. In an embodiment, a device 200 includes housing 205 having a front surface 212. A display surface 220 may also be included on or with the housing 205. The display surface 220 may be part of a display assembly that includes hardware and logic that communicates with an internal processor of the device 200. The display surface 220 may be flush and/or formed with the front surface 212, or alternatively separately formed and provided apart from the front surface 212.

In an embodiment, a keypad 210 may be provided on an input area 218 of the housing 205. The input area 218 may be provided on or form part of a moveable panel construction, such as described with any of the embodiments of FIG. 1A-1C. The input area 218 may be defined in part by positioning of sensors that define a sensor area 228 in which presence and position of an object or finger in contact or proximity (e.g. hover just above) with the keypad 210 is determinable. In one embodiment, the sensor area 228 may include an area that encompasses all of the footprint of the keypad 210. The sensor area 228 may also extend beyond the boundaries of the keypad 210, particularly in embodiments where the keypad is sizeable (e.g. see FIG. 4A).

The keypad 210 may be made operative by logic and hardware such as described elsewhere in this application. Additionally, one or more embodiments provide that keypad 210 has more than one layout of key-value assignments. Moreover, embodiments described herein enable the keypad 210 to display or illuminate multiple layouts, and/or provide alternative layouts for the keypad in which dimensions or count of individual keys, or key rows/columns, is altered with light or computer-generated content. Each layout may carry a set of key assignments, where one or more key values are assigned to individual keys. In one implementation, the layout provides key values that form a QWERTY (or QWERTY-like) keyboard. However, as described with one or more other embodiments, different layouts may be provided or generated from the same region of the keypad 210. The layout may specify, for example, the class of keypad (e.g. QWERTY versus number pad), number of input regions (e.g. 40 input regions for character based keypad), the number of key values assigned to each input region (e.g. alternative character, numerical and/or special character modes for a given “key”), and the configuration of the keypad (e.g. row-wise and smiley-face arrangement of input regions). Additionally, a given layout may have different modes of operation, where, for example, an individual input region 219 may be provided an alternative key value. The device 200 may also be configured to provide different keypad layouts, and the implementation of a particular layout may depend on the device mode.

In one embodiment, the keypad 210 is mechanical or structural in nature, and the layout of the keypad 210 is relatively static. As such, input region 219 (FIG. 2B) may be static and designated. In such an embodiment, the input region 219 may include structures that extend outward from the front panel 208.

In another embodiment such as described with FIG. 3A, the keypad 210 may be defined in-part by lighting or a light-emitting layer, provided underneath or as part of the front panel 208. Optionally, under such an embodiment, the keypad 210 may have alternative layouts available from one surface, dependent on the backlighting having a state of being lit or unlit at specific areas of the input region 219. In particular, one or more embodiments provide that different layouts may be available from one keypad depending on the mode of use for the device or keypad. For example, both a QWERTY keyboard and number pad may be available from one keypad. Backlighting (without content generation) may define individual keys of each keypad in use for a particular mode, including dimensions or layout of the individual keys in each available layout. As with an embodiment of FIG. 1D, a key structure thickness may define the input regions and extend from the front panel 208. Such structures may be translucent to carry light outward and thus enable the mode-settings of the keypad 210 to be effective.

Still further, an embodiment such as described with FIG. 4A, keypad 210 includes a keypad that includes computer-generated content and/or design, including key content, layout, and/or dimensions (overall, row-wise, column-wise etc.). According to one or more embodiments, a display assembly may generate light that is emitted through a translucent key structure or thickness. The light illuminated from the display may at least partially define any one or more of (i) key content, (ii) layout, particularly for a mode of use (e.g. number pad layout and keyboard layout), (iii) key configuration or design, (ii) key shape or dimension, (v) row or column size or configuration, and/or (vi) overall size of configuration of the keypad. The key content may display key values selectively, based on the mode of operation of the device or keypad. For example, the key value assignment for a given input region 218 (FIG. 2B) may be changed through display content, based on the mode operation of the device.

In an embodiment, keypad 210 may be overlaid or integrated with at least a portion of a display surface that forms part of a display assembly. The display assembly may correspond, extend from or otherwise integrate with the an assembly for the display surface 220. For example, keypad 210 may be overlaid on an extension of the display surface 220. Alternatively, a separate display assembly and/or surface may be used from that of display surface 220.

The input regions 219 may be provided with changeable graphics, as well as varied in size and configuration. In an embodiment, keypad 210 may be provided with anyone of multiple layouts or configurations, depending on the displayed key content, pattern, or illumination pattern of the display surface. For example, keypad 210 may be displayed in the form of a keypad or numeric pad, have key structures that can vary in size, and/or have individual graphics of specific keys varied in dimension, content, format or otherwise. As an alternative or addition, the input region 218 may be replaced in its entirety with various kinds of display content.

FIG. 2B illustrates an implementation of a key value assignment scheme for a particular keypad layout, according to an embodiment of the invention. For an embodiment such as described with FIG. 2A, individual input regions 219 may be assigned one or more key values that are identified when the respective input region is contacted with sufficient force to trigger a key-press event. A discrete contact 231 provided at or just above one of the input regions 219 may be sufficient to trigger a key-press event. In the event of a key-press event, the value of the input region 219 is determined from sensors that detect which input region was contacted when the key-press event occurred. This value may be affected by the mode setting or other layout configuration of keypad 210 in use at the time of the key press event. For example, a given input region may have both alphabet and numeric assignments, depending on mode of operation.

The specific value assigned to the key-press event may depend on the mode setting of the device at the approximate time of the key-press event. As an example, some input regions 219 may include as default a letter value assignment, unless numeric mode is initiated, in which case the same region may have a number value assignment. At the time the key-press event occurs, processing resources of the device detect which input region 219 was contacted from the position information, identify the mode setting of the device or keypad, and then determine the value of the key-press event. This contrasts to more traditional approaches where the actuated switch element is what determines the particular key that was pressed.

As described with, for example, an embodiment of FIG. 1D, absent the key-press event, a user-contact with the input region may either supply position information, and/or have no effect. For example, a contact 233 corresponds to a trace input that simulates mouse or pointer movement by the user, except the user employs the input by moving a finger or object over the individual regions 219 without applying sufficient force to trigger a key-press event. In the absence of sufficient force to trigger the key-press event, the movement of the pointer or finger over the keypad 210 (with or without actual contact) may be detected and interpreted as position-only input.

Keypad Assembly with Positional Backlighting Variation

FIG. 3A is a simplified side view of a keypad assembly that includes positional backlighting variation to alter graphics and content appearing on a key of a keypad, according to an embodiment of the invention.

As with an embodiment of FIG. 1D, a keypad 312 may be provided on a moveable platform 306 of the housing 308 of a mobile computing device 300. The keypad 312 may provide a contact surface 302 formed from a key structure layer 310. Additionally, the keypad 312 may include a sensors 320 and an actuation platform 330. A light-emitting layer 340 is provided underneath the key structure layer 310 to illuminate key structures individually or in sets. The light-emitting layer 340 may be static, in that the layer, or portions thereof, may turn on, switch off, or dim. But the light-emitting layer does not itself generate display content, as described with an embodiment of FIG. 4A. In one implementation, the light-emitting layer 340 is a distributed light source, such as provided with an EL panel. As an alternative or addition, discrete light sources such as LEDs may be selectively distributed on a backplane. In one implementation, the light-emitting layer 340 may be disposed between the key structure layer 310 and the actuation platform 330. The proximity of the light emitting layer 340 to the key structure layer 310 may vary, depending on design parameters and the type of lighting source used.

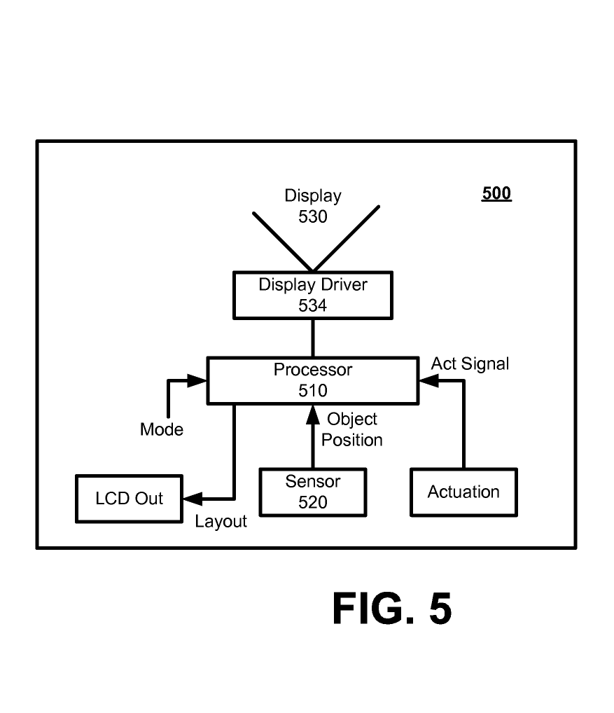

As described with, for example, an embodiment of FIG. 1D, the sensor 320 and the actuation platform 330 are each coupled to processing resources 510 (see FIG. 5). The sensor 320 may detect presence and position of an object when it makes contact with a surface of the key structure layer 310. In one embodiment, the processing resources 510 ignore the position of the object or finger unless the object or finger is pressed inward with sufficient force to move the platform 306 inward, so as to trigger or actuate one or more actuation elements of the platform 330. In another embodiment, position information provided by the finger on the keypad may be used for alternative input (e.g. directional or scrolling) in the absence of a key-press event. The platform 330 may be constructed in, for example, a manner described with the actuation platform of an embodiment of FIG. 1D.

As described with an embodiment of FIG. 1D, the key structure layer 310 may be moved inward to trigger the key-press event, corresponding to one or more of the elements 332 of the actuation platform 330 being triggered. The key-press event may result in the identification of a key value assigned to that key structure, based on position information provided by the sensor 320, and the particular mode in operation. Thus, under an embodiment, the particular contact element 332 that is actuated may play no role in determining which key structure was actually contacted by the user. Rather, the position information from the sensors 320 is used to identify the key structure or region of the finger or object at the time of the key-press event, and the processing resource converts that position information into a key value assigned to that region, for the particular device or keypad mode.

Additionally, the keypad 312 may be provided on a panel or surface of a mobile computing device, such as used to enable cellular telephony or data communications. Keypad 312 may provide, for example, a keyboard (such as a QWERTY keyboard) or numerical pad for enabling a user to provide alphanumeric input to a mobile computing device. Further, as described with other embodiments, sensors 320 is coupled to provide position information to the processing resources 370 of the device.

In order to promote or facilitate light transfer through the key structure layer, the key structure layer is formed at least partially from material that is transmissive to light, so as to enable light from underneath the keypad 310 to pass through the individual key structures. In one embodiment, at least some of the key structures 310 are milky. Milky key structures contains some white or off white color in at least a portion of the thickness of their respective body, so as to enable the key structure to be both transmissive to and distributive of light. As an alternative or variation, the key structure 310 may be cleared, hollow, or partially hollowed or shaped to enable at least some light to pass through the key structure.

In addition to the structures 310, the sensors 320 may be positioned to avoid occlusion of light emitted from the light emitting layer 340. As an alternative, the sensors 320 or portions thereof may be formed from clear or translucent material to enable light to pass onto and through the key structures.

As a keypad, individual key structures may carry one or more key value assignments. At least some of the key structures 310, 312, 302 that comprise the keypad may have multiple key value assignments, which may be selectively in use depending on a mode setting. Furthermore, at least some of the key value assignments are displayed on the actual key structure. The keypad 312 may be illuminated with a backlight to cause illumination of one or more key value assignments on the keypad 312. In particular, the use of illumination under the key structure layer 310 may be implemented in any one of several ways: (i) illumination may be selectively (in-time) or globally provided for an entire region under the keypad 312; (ii) illumination may be provided selectively (positionally) under areas of select input regions or structures; and (iii) an described with an embodiment of FIG. 3B and FIG. 3C, the illumination may be selectively provided under areas of individual input regions or keys of the keypad 312, so as to illuminate one portion of one key structure over another portion of that same key structure.

One or more embodiments provide for a light mask 314, such as a printed surface, to enable selective illumination and/or non-illumination (or darkening) of individual key structures 312 or sets of key structures. The light mask 314 may be formed in a plane or thickness of the key structure layer 310 to enable effects of illumination. The light mask 314 may be provided, for example, on contact surface 302 or underneath the structure 310. The light mask 314 may define through patterning or otherwise the displayed content on each key structure. The layout may correspond to, for example, the letter and/or number assignments of individual key structures. In an embodiment, the light mask 314 reflects a layout where some key structures 308 are set to be illuminated differently, depending on the mode of operation of the device or keypad. In another embodiment, the light mask 314 enables some key structures, or portions of some key structures, to be darkened or hidden (e.g. “disappear”) with use of selective illumination and non-illumination.

According to one embodiment, illumination of the key structure layer 310 is performed to visually differentiate one set of input regions or key structures from another. In one embodiment, regions of the light-emitting layer 340 that correspond to differentiated key structures 308 or regions may be selectively illuminated apart from other structure/regions to enhance the presence of some illuminated keys in a particular mode of operation for the device of keypad. For example, in one embodiment, ten keys of a keypad are visually differentiated to reflect a number pad. The key structures 312 that comprise the number pad may have default numeric value assignments when the device is operated in a numeric mode (e.g. when the device detects the user entering a phone number), and character values hen the device is operated in an alphabetic or character mode. The illumination layer 340 may be selectively illuminated to lighten only the key structures of the numeric pad. In this way, some of the key structures 308 may be differentiated in appearance from other key structures with shading, imprint, pattern, or color.

FIG. 3B and FIG. 3C illustrate an implementation of an embodiment of FIG. 3A, in which light-emitting layer 340 may be operated to selectively illuminate under portions of individual key structures, so as to illuminate and/or darken one portion of a key structure from another. In one embodiment, the selective illumination may reflect mode operation of the keypad or device (and the corresponding key value assignments that are default in that mode setting). An embodiment such as described with FIG. 3A enables the use of EL panels, which can be configured to illuminate in such discrete patterns. Specifically, conventional keypad design normally uses plungers or extensions from key structures to individually actuate underlying contact elements. A keypad under one embodiment may eliminate the use of individual plungers from key structures or regions, so as to permit more unobstructed passage of light. Thus, the use of the EL panel as an illumination layer in a manner such as shown and described with FIG. 3B and 3C is promoted by the omission of plungers. At the same time, individual key structures can be pressed and provided tactile feedback from the spare electrical contacts 332 on the actuation platform 330.

In an embodiment of FIG. 3B and FIG. 3C, keypad 312 has defined key structures, of which a select set 346 has multiple key value assignments. The key value assignment for an individual key structure may depend on the mode of operation of the device of keypad. The current key value assignment of individual keys may be displayed for the user at any given instance using selective lighting under each key structure that has multiple key value assignments. The select set 346 of key structures may display key value assignments apart from one another on the same key structure or input region.

For example, the select set 346 of key structures may display alphabet characters on one side of the individual key region, and numbers on another side of the key region. FIG. 3B illustrates illumination of the alphabet characters in the select set 346, with the EL panel being operated to darken or hide the number values of the same keys. In FIG. 3C, the converse is shown for the select set of keys 346, where the numerical values are illuminated, and the alphabet characters are darkened or hidden. In use, the portion of the key structure that is illuminated reflects the desired key value assignment for the particular mode of operation. For example, in alphabet mode, the key value assignment of the select set 346 illuminates the right half or portion of the select set 346, where a letter value is displayed. In numeric mode, the key value assignment of the select set 346 illuminates the left hand of the portion of the select set, where a number value is displayed.

With reference to FIG. 3B and 3C, the light mask 314 (FIG. 3A) my be designed in accordance with a keypad layout that defines the values of key structures in various modes of operation of the device, of the keypad, or of the individual key. The mask 314 may be designed so that each key value assignment that can be illuminated from a given key structure 308 occupies only a portion of the total footprint assigned to that key structure. In one embodiment, an individual key structure is assigned multiple key values, each of which may be illuminated to display or enhance display of one of its key value assignments over another. In an example shown by FIG. 3B, ten key structures 346 of keypad 305 have dual alphabet and numeric assignments. For each of the those key structures, the alternative values are imprinted or otherwise displayable with backlighting. At a given instance, each key structure 346 may be illuminated to display, or enhance display of, just one key value imprint, while the other key value assignment is unlit. The display or enhancement may be performed by selectively displaying a portion of the key structure that is just under the desired key value imprint. When the mode operation of the key structure of keypad 305 is switched, another portion of the key structure that is just under the imprint of the other of the desired key assignment is illuminated.

FIG. 3B illustrates keypad 305 operational in alphabet mode. In the example shown, some key structures 348 only have alphabetical key value imprints, while select key structures 346 have both alphabetical and numerical key value imprints. In the alphabet mode, the key value imprints of the keypad 305 are lit. The select key structures 346 in the keypad 305 include both alphabet and numeric key value imprints. In alphabet mode, the backlighting under select key structures 346 is divided or proportioned so that the alphabet key value imprints are backlit, while the numeric key value imprints are unlit and less visible. The other key structures 348 which have alphabetical imprints may be fully lit. The mask 314, in conjunction with the selective positional lighting of the EL panel, may enable non-illuminated regions of at least some keys to be darkened or “hidden”. In alphabetical mode, the mask 314 may shield the numerical value imprints of the select key structures, while enabling the key value imprints to be fully lit.

FIG. 3C illustrates keypad 305 in numerical mode. In numerical mode, the mask 314 shields the key structures 348 that only have alphabetical values, while illuminating regions under the select key structures 346 where numerical value imprints are located. The mask 314 may shield to lessen illumination of portions of key structure 346 having alphabet value imprints.

While examples described with FIG. 3B and FIG. 3C show alphabetical and numerical assignments, numerous key value assignments that are alternatives to letters and numbers may be implemented. For example, key value assignments may include imprints special characters (e.g. “@)”), punctuations, icons for application actions or launches, or user-interface control features.

Keypad Using Display Assembly

FIG. 4A is a side view of a keypad assembly that includes a display screen to enable computer-generated graphics to define keys and/or contents of keys on a keypad, according to an embodiment of the invention. In an embodiment, a keypad 405 of mobile computing device 400 enables graphics to be generated from software or other logic, through, for example, use of internal processing resources 470 of the device. Thus, unlike an embodiment of FIG. 3A, graphics and other content may be generated for individual keys of the device without use of imprints or pre-designated assignments to portions of individual keys. Additionally, one or more embodiments provide that the layout, configuration, and size of individual keys, rows/columns or the keypad as a whole may be altered with software or logic.

The keypad 405 may be provided with or as part of a platform 406. The platform 406 may be provided with or as part of the housing 408 of the device. A contact surface 402 may be formed from an exterior of a key structure layer 410. Additionally, the keypad 405 includes a sensor layer 420 and an actuation platform 430. A display component 440 is provided underneath the key structure layer 410 to generate content that forms portions of the keypad 405. In one implementation, the display component 440 is a liquid crystal display (LCD) assembly that is coupled to processing resources 470 and logic (e.g. display driver).

The platform 430 may be constructed in, for example, a manner described with the actuation platform of an embodiment of FIG. 1D. The display component 440 may be part of the main display component of the device, or alternatively a separate display device. Use of a single display component, however, includes cost-savings.

In one embodiment, the display component may comprise an LCD on which a glass panel is superimposed. Optionally, a clear touch panel may be provided over the glass panel. In one implementation, the touch panel serves as sensor 420. While the touch panel may detect contact, inadvertent contacts may be distinguished from deliberate contacts that are intended to be key-press events by use of the actuation panel 430.

As described with other embodiments, for example, processing resources may couple to the actuation platform 430 and/or sensors 420 via a flex cable 472 or other mechanism. In one implementation, the actuation platform 430 may comprise four or more dome switches. However, the actuation of one dome switch is not distinguished from the actuation of another dome switch.

In operation, the display component 440 may emit content lighting underneath the key structure layer 410, so as to generate graphics, layout and/or configuration of a keypad on the medium of the key structure layer. As described with one or more other embodiments, the key structure layer 410 may be translucent to light. Additionally, one or more embodiments provide that the key structure layer 410 is milky in at least portions or regions.

In one embodiment, the key structure layer 410 is in the form of spaced or separately formed structures 412 that individually deform. The structures 412 may extend outward from a shared surface 414. The surface 414 may be combined with platform 406 so as to move inward when any of the structures 412 is pressed. Platform 406 may be constructed in a manner described with any of the embodiments described with FIG. 1A-1C. The contact element 432 may be constructed to have a characteristic force that causes the element to trigger. For example, the contact element 432 may correspond to a snap dome element that collapses with a force of 220 Newtons. Only a force that is greater than the characteristic force of the contact element 432 causes a key-press event.

In one embodiment, platform 406 may be constructed so that the entire key structure layer 410 moves inward with the user pressing just one of the structures 412. Additionally, inward movement of platform 406 may result in the inward movement of the sensor layer 420 and the display component 440. Thus, under one embodiment, the user triggers a key-press by pressing one of the key structures 412 with sufficient force to move the entire key structure layer 410, sensor layer 420 and display component 440 inward with sufficient force (i.e. greater than the characteristic force) to cause the contact element 432 of the platform 430 to trigger. Processing resources 470 determine from the sensor layer 420 the position of the finger when the key-press event is detected. The position of the finger may be correlated with a particular key or position, and/or a key value (that may be mode dependent). In this way, the key-press is interpreted as an input.

An embodiment such as described with FIG. 4A enables use of a rigid display component such as an LCD, which can provide brighter and richer content for the keypad. In one embodiment, the LCD is positioned just under the key structures, so that its illumination is not affected with intervening plungers or other layers or structures. The sensor layer 420 may maintain an adequate level of sensitivity in detecting a finger or object on contact surface 402. Moreover, the ability for the key structure layer 410 to move inward to gate or trigger a key-press event protects the integrity of the LCD. Specifically, the LCD is not exposed to bending or deflection as a result of a user's interaction with the key structure layer. The rigidity of the LCD would otherwise expose the LCD to damage from bending or deflection.

According to an embodiment, the combination of the display component 440 and the key structure layer 410 provide a keypad that has a conventional, mechanical feel, while at the same time having visual characteristics that are computer-generated. As such, various visual characteristics of the keypad may be altered or changed with software or other logic that controls operation of the display component 420. In particular, display component 420 may be controlled to generate graphics that provide, for example, the graphics displayed within the boundaries of individual key structures 412 or regions thereof, including, for example, alphabet or numbers designating corresponding character values, as well as icons that represent functions or operations. The font, image, format, illumination and color of the surface of the key structure, or its content, may all be changed with output from the display component.

FIG. 4B and FIG. 4C illustrate an embodiment in which keypad 405 of an embodiment of FIG. 4A can change graphics. In FIG. 4B, the display component 420 provides output that casts a QWERTY keyboard layout onto keypad 405. The layout of FIG. 4B may be generated when the device or keyboard is operated in an alphabet mode. In FIG. 4C, the keypad 405 changes its appearance by (i) replacing the content of some keys with numbers (for number assignments in a numeric mode of operation), and (ii) hiding or de-illuminating key structures that are not used with the numeric keypad.

In addition to changing graphics, one or more embodiments provide that the size and/or configuration of individual key structures may also be changed. Such an embodiment may employ a key structure layer 410 that is relatively continuous, so that the output of the display component 420 may delineate key region, rather than spacing or surface structures. For example, the key structure layer 410 may comprise a relatively continuous sheet or thickness, formed from translucent material. In such an embodiment, the configuration and layout of the keypad 405 may be defined by the output of the display component. FIG. 4D illustrates an embodiment in which a number pad 470 is enlarged and appears in a greater area than what was shown with an embodiment of FIG. 4C. For example, display component 420 may be configured to display a keyboard and a number pad in the same footprint, so that the size of the keys of the number pad are enlarged as compared to the size of the keys of the keyboard.

Furthering the example of FIG. 4D, an embodiment of FIG. 4E illustrates the display component switching from any of the modes shown with FIG. 4B and FIG. 4C to a mode shown with FIG. 4D. In an implementation of FIG. 4E, keys 482 of the keypad may be designated for application functions and launches. The layout may be provided along one line, and the keys representing soft buttons may change shape (e.g. become square) and dimensions (larger).

Numerous variations and alternatives to embodiments and implementations described with FIG. 4A-4E are contemplated. Features such as contents of individual keys, the layout of the keys, dimension of individual keys, look of graphics provided on individual keys, and the symbol representing a function or value assigned to the key at a given instance are design parameters for an embodiment such as described.

In addition to displaying content for keys of the keypad, one or more embodiments provide that the graphics illuminated from the display device 440 may be responsive to receiving user contact. For example, the display device 440 may display a graphic when it detects a key-press event, as a form of visual feedback to the user.

The display component 440 may also display content not related to its usage as a keypad. For example, when not in use, the display component 440 may display images or act as a screen saver.

Hardware Diagram

FIG. 5 is a simplified hardware diagram of a computing device configured to implement one or more embodiments of the invention. In an embodiment, a device 500 includes a processor 510, sensors 520, a display 530, and a display driver for the display 53. Device 500 may also include an actuation mechanism 544. Other components such as memory resources and wireless communication components are not shown, but may be included as part of the device hardware. Device 500 may be configured to in accordance with, for example, an embodiment of FIG. 4A, Accordingly, an embodiment provides for a keypad display 532 to be coupled to the processor 510.

Sensors 520 provide position information 522 indicating a position of an object in contact with or hovering just above a contact surface of a keypad. Actuation mechanism 544 may trigger signals indicating that the platform (not shown) is moved inwards. Processor 510 may interpret the combination of triggering signals from the actuation mechanism 544 and position information 522 from sensors 520 as a key-press event, associated with a specific key identified from the position information.

In one embodiment, the processor 510 may generate content or portions of the keypad using the keypad display 532, as described with, for example, embodiments of FIG. 4A-FIG. 4E. The keypad display 532 may be a separate component from the output display 538. Still further, the keypad display 532 may use a separate display driver (not shown).

As an alternative, processor 510 may control a backlighting mechanism (not shown) instead of the keypad display 532, in a manner described with, for example, embodiments of FIG. 3A-FIG. 3C. In one embodiment, a backlighting mechanism may be selectively illuminated in time and/or position to illuminate one keypad configuration over another.

### Alternative Embodiments

While numerous embodiments described herein provide for a platform segment that is moveable inwards in order to trigger a signal from the actuation platform, other embodiments contemplate other types of housing segments or platforms for detecting user contact. In particular, a keypad or keyboard may be provided on a region of the housing that is not necessarily moveable inwards, but rather may be fixed in connection with other portions of the housing and configured to detect contact from an object or finger. In one embodiment, a keypad is provided on a platform that is deformable inward. The amount of deformation exhibited on a region of the platform may be measured in order to determine whether a contact was applied with sufficient force to be recognized as a key-press event.

As an alternative or addition, compressive force sensors may be distributed on the moveable segment, or alternatively on a section of the housing where the keypad is provided. The compressive force sensors may detect contact from a finger or object that is above some threshold level. When such forces are felt, the key-press event is interpreted. As described with one or more other embodiments, the position of the object causing the key-press event may be determined from position sensors, which operate in cooperation with compression sensors that detect the threshold force. The application of compressive force sensors may be applied in a manner that provides a binary status as to whether a threshold force has been applied to the entire platform as a whole.

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventor from claiming rights to such combinations.

1. A method for operating a keypad of a mobile computing device, the method comprising:
associating each of a plurality of regions within a panel of the keypad with a key value;
detecting inward movement of the panel as a result of application of a force in excess of a threshold;
determining a position of a finger or a pointer, either in contact with or in operational proximity to the panel, when the inward movement is detected; and
determining the key value corresponding to one of the plurality of regions that is encompasses or is proximate to the position.

2. The method of claim 1, wherein associating each of a plurality of regions within a panel of the keypad with a key value includes assigning two or more values to one or more of the regions in the plurality, each of the two or more key values being for one of two or more mode settings of the device, and wherein determining the key value includes selecting the key value for a particular mode setting of the device at an instance when the platform is moved inward.

3. The method of claim 2, wherein the two or more mode settings include an alphabet mode and a numeric mode.

4. The method of claim 1, further comprising illuminating the key value of one or more of the plurality of regions.

5. The method of claim 2, further comprising selectively illuminating one of the two or more key values based on one of the two or more mode settings.

6. The method of claim 5, wherein selectively illuminating one of the two or more key values is performed using an electroluminescent (EL) panel.

7. The method of claim 1, further comprising generating a graphic representation of one or more of the key values at one or more of the plurality of regions.

8. The method of claim 2, further comprising selectively generating one of the two or more key values based on one of the two or more mode settings.

9. A mobile computing device comprising:
a housing comprising a front surface that includes a panel segment;
a key structure layer provided with or as part of the panel segment;
a processing resource provided within the housing, wherein the processing resource is configured to associate each of a plurality of regions of the key structure layer with a corresponding key value;
a position sensor provided in operational proximity to the panel segment and coupled to the processing resource to detect a position of an object that is in contact with, or in proximity to, the key structure layer;
an actuation mechanism positioned with respect to the panel to be actuated when a force is applied to any portion of the key structure layer that exceeds a threshold range, the actuation mechanism being coupled to the processing resource to signal the processing resource when actuated; and
wherein the processing resource is configured to identify the key value associated with the position of the object when the actuation mechanism is actuated.

10. The mobile computing device of claim 9, wherein the key structure layer is separated into a plurality of key structures.

11. The mobile computing device of claim 9, wherein the key structure layer includes a thickness that provides a continuous contact surface for the key structure layer.

12. The mobile computing device of claim 9, wherein the position sensor is capacitive.

13. The mobile computing device of claim 9, wherein the position sensor is resistive.

14. The mobile computing device of claim 9, wherein the actuation mechanism corresponds to a switch that is provided underneath the panel segment, and wherein the panel is structured to cause the switch to actuate when the force is applied to the key structure layer.

15. The mobile computing device of claim 14, wherein the panel segment is moveable inward from the front surface of the housing, and wherein the panel segment is structured to move into and physically cause the switch to actuate when the force is applied to the key structure layer.

16. The mobile computing device of claim 15, wherein the switch includes a snap-dome electrical contact.

17. The mobile computing device of claim 9, further comprising an illumination panel that underlies at least a portion of the panel segment to illuminate one or more regions of the key structure layer.

18. The mobile computing device of claim 17, further comprising a mask layer that is provided with the key structure layer, wherein the mask layer provides an imprint that visually defines one or more of the key values when the key structure layer is illuminated by the illumination panel.

19. The mobile computing device of claim 18, wherein the key structure layer is identifiable as a plurality of regions, and wherein the mask layer provides an imprint that visually defines two or more key values or a given one of the plurality of regions when the key structure layer is illuminated by the illumination panel.

20. The mobile computing device of claim 10, further comprising a display component provided underneath the key structure layer, wherein the display component is coupled to the processing resource to display graphics through the key structure layer.

21. The mobile computing device of claim 20, wherein the displayed graphics correspond to one or more of (i) a visual boundary of a key on the keypad, (ii) a content of a key on the keypad, (iii) a shape or dimension of a key on the keypad, or (iv) a layout of the keypad.

22. The mobile computing device of claim 20, wherein the processing resource is configured to generate graphics for the display corresponding to individual key values for each of the plurality of regions, so that the display component illuminates, through a region of the key structure layer, at least one graphic representation of a key value assigned to that region.

23. The mobile computing device of claim 22, wherein the processing resource is configured to identify a substitute key value for at least some of the plurality of regions responsive to a mode setting of the mobile computing device, and wherein the processing resource causes the display component to display the substitute key value for the at lest some of the plurality of regions in response to detecting the mode setting.

24. The mobile computing device of claim 11, wherein the processing resource is further configured to cause the display component to display the keypad, with each of the plurality of regions, including either the key value or the substitute key value, depending on the mode setting of the mobile computing device.

25. A mobile computing device comprising:
a housing;
a platform segment provided with or as part of the housing so as to occupy a portion of a front face of the device;
a coupling mechanism that couples the platform segment to at least a portion of the housing so as to enable the platform segment to be moved inwards and outwards with respect to an interior of the housing.

26. The mobile computing device of claim 25, wherein the coupling mechanism includes a hinge that enables the platform segment to pivot inwards and outwards.

27. The mobile computing device of claim 25, further comprising:
a processing resource; and
an actuation mechanism provided underneath the platform segment and coupled to the processing resource, wherein the actuation mechanism is positioned to be actuated with inward movement of the platform segment.

28. The mobile computing device of claim 3, wherein the processing resource performs a function associated with the actuation mechanism being actuated by inward movement of the platform segment.

29. The mobile computing device of claim 28, wherein the platform segment provides one or more input mechanisms.

30. The mobile computing device of claim 28, wherein the platform segment provides a plurality of input mechanisms, including at least a set of keys for a keypad.

31. A keypad assembly for a mobile computing device, the keypad assembly comprising:
a platform segment provided on or as part of a housing of the mobile computing device, the platform segment including a keypad surface that occupies a portion of a front face of the device;
a coupling mechanism that couples the platform segment to at least a portion of the housing so as to enable the platform segment to be moved inwards and outwards with respect to an interior of the housing.

32. The keypad assembly of claim 31, further comprising a display device positioned to illuminate the keypad surface with a content for an individual key of the keypad.

33. The keypad assembly of claim 32, further comprising a key structure layer provided on the platform segment to provide the keypad surface, and wherein the content is illuminated through the key structure layer.

34. The keypad assembly of claim 33, wherein the key structure layer is shaped to delineate individual keys or portions of the keypad.

35. The keypad assembly of claim 34, wherein the key structure layer includes a thickness that is extended continuously across a span of the platform segment.

36. The keypad assembly of claim 33, further comprising: one or more sensors that detect a position of an object on the platform segment; and an actuation mechanism that detects when the platform segment is moved inward.

37. The keypad assembly of claim 36, wherein the one or more sensors communicate position information to a processor of the mobile computing device, and the actuation mechanism signals the processor when the platform segment is moved inward.

38. A segment for a housing of a mobile computing device, the segment comprising:
a platform segment provided on or as part of the housing of the mobile computing device;
a key structure layer provided on the platform segment, the key structure layer including a keypad surface that occupies a portion of a front face of the device;
a coupling mechanism that couples the platform segment to at least a portion of the housing so as to enable the platform segment to be moved inwards and outwards with respect to an interior of the housing.

39. The segment of claim 38, wherein the platform segment is positioned over a backlighting.

40. The segment of claim 28, wherein the platform segment is positioned over a display component.
